(19) United States
(12) Patent Application Publication
(10) Pub. No.: US 2004/0183320 A1
(43) Pub. Date: Sep. 23, 2004

(54) Bi-directional gripping of rectangular devices/components

(76) Inventors: Brian Evans, Marshfield, MA (US); Dave Greco, Saugus, MA (US)

Correspondence Address: IRELL & MANELLA LLP, 840 NEWPORT CENTER DRIVE, SUITE 400, NEWPORT BEACH, CA, 92660, US

(21) Appl. No.: 10/392,526

(22) Filed: Mar. 19, 2003

(51) Int. Cl. B25J 15/08

(52) U.S. Cl. 294/88

(57) ABSTRACT

A mechanical gripper with a first clamp that can grab a workpiece in a first direction and a second clamp that grabs the workpiece in a second direction. The second direction is essentially perpendicular to the first direction so that the second clamp secures the workpiece onto the first clamp. Clamping in two different directions prevents relative movement of the workpiece within the gripper.

### BACKGROUND OF THE INVENTION

1. Field of the Invention

The present invention relates to mechanical grippers.

2. Background Information

Automated grippers can be used to pick and move workparts in an industrial process. For example, automatic grippers can be used to grab and move integrated circuits onto an integrated circuit package or printed circuit board. A system that automatically moves integrated circuits is sometimes referred to as a pick and place machine. Some pick and place machines have a pneumatic “pencil” that grabs the integrated circuit. The pneumatic pencil relies on a vacuum force to hold the device. Unfortunately, any external force may move the integrated circuit on the pencil. Such movement may result in a misalignment of the integrated circuit on the package or printed circuit board.

Some grippers include a mechanical clamp that grabs the sides of the part. Like the pneumatic pencil such grippers may allow movement of the part in response to an external force. Such movement may also result in a misalignment of an integrated circuit placed onto a package or printed circuit board. Additionally, integrated circuits are relatively brittle. Movement of the integrated circuit within the gripper may chip the corners of the device.

### BRIEF SUMMARY OF THE INVENTION

A mechanical gripper that has a first clamp that can move along a first axis and a second clamp that can move along a second axis.

### BRIEF DESCRIPTION OF THE DRAWINGS

FIG. 1 is a side view of a mechanical gripper;

FIG. 2 is a bottom view of the mechanical gripper.

### DETAILED DESCRIPTION

Disclosed is a mechanical gripper. The gripper includes a first clamp that can grab a workpiece in a first direction and a second clamp that grabs the workpiece in a second direction. The second direction is essentially perpendicular to the first direction so that the second clamp secures the workpiece onto the first clamp. Clamping in two different directions prevents relative movement of the workpiece within the gripper.

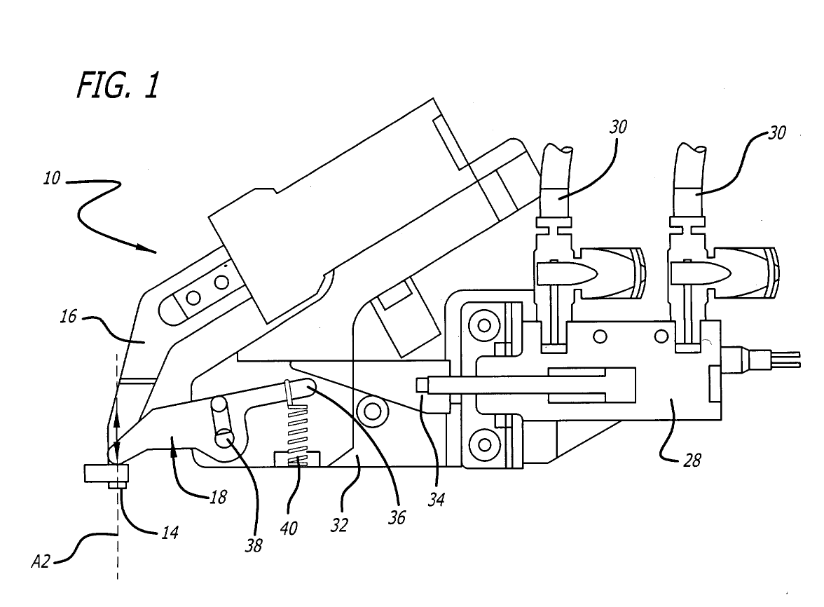

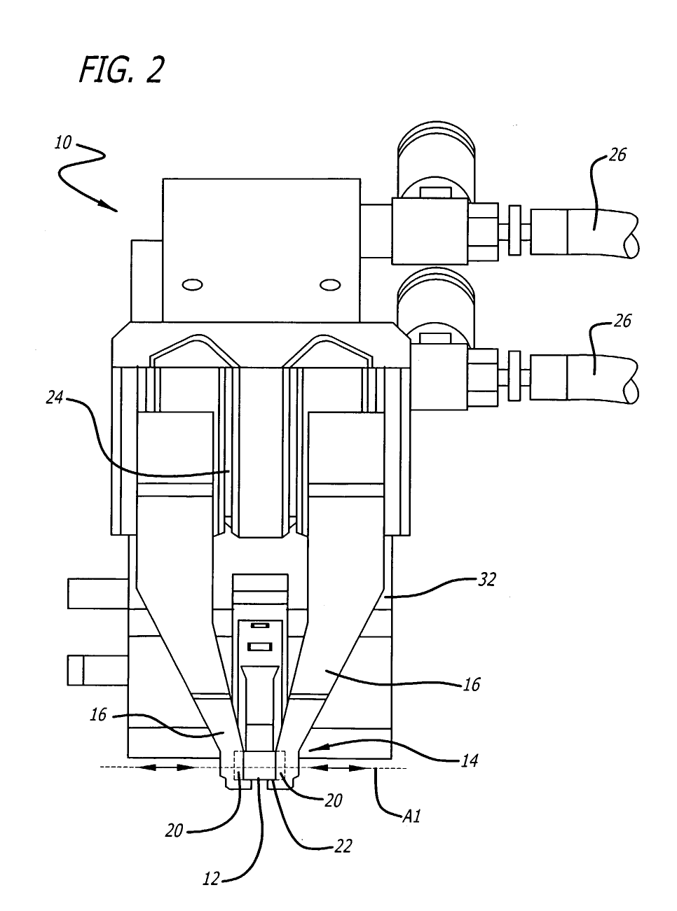

Referring to the drawings more particularly by reference numbers, FIGS. 1 and 2 show a mechanical gripper 10 that can grab a workpiece 12. By way of example, the workpiece 12 may be an integrated circuit that is to be moved from a tray to an integrated circuit package, or a printed circuit board. The gripper 10 may be attached to a robotic arm (not shown), or other automated equipment that can move the workpiece in one, two or three dimensions.

The gripper 10 includes a first clamp 14 that moves along a first axis A1, as indicated by the arrows in FIG. 2. The first clamp 14 may include two separate fingers 16 that can move in an inward direction to apply grasping forces to the ends of the workpiece 14 and an outward direction to release the part 14. The gripper 10 further includes a second clamp 18 that moves along a second axis A2 as indicated by the arrows in FIG. 1. The second clamp 18 may actually move along a radial arc and make contact with the workpiece 14 on the second axis A2.

The second axis A2 may be essentially perpendicular to the first axis A1 so that the second clamp 18 exerts a force that inhibits movement of the workpiece 12 within the first clamp 14. The dual clamps 14 and 18 prevent movement of the workpiece 12 within the gripper 10. Such a gripper configuration improves the alignment of the workpiece 12 onto another part such as an integrated circuit package or a printed circuit board.

The first fingers may have shelves 20 that provide a seat for the workpiece 12. The first clamp 14 may be interchangeable so that different size shelves 20 may be provided for different size workpieces 12. Additionally, the fingers 16 may have an L-shaped portion 22 that impedes movement of the workpiece 12 within the gripper 10.

The first clamp 14 may be coupled to a first actuator 24 that moves the clamp fingers 16 in the inward direction and the outward direction. The first actuator 24 may be a pneumatic cylinder that is coupled to a pair of pressure air lines 26. The flow of air may be controlled by an air valve (not shown) that is coupled to an electronic controller (not shown).

The second clamp 18 may be coupled to a second actuator 28. The second actuator 28 may also be a pneumatic cylinder that is coupled to an air valve and the controller by air lines 30. The first 24 and second 28 actuators may be mounted to a housing 32.

The second actuator 28 may be attached to a linear cam 34 that engages a cam follower portion 36 of the second clamp 18. Actuation of the second actuator 28 to an extended position will move the linear cam 34 and cause the second clamp 18 to rotate about a pivot pin 38 to an upward position. Actuation of the second actuator 28 to a retracted position will move the linear cam 34 back and allow a biasing spring 40 to rotate the second clamp 18 to a downward position. The spring 40 is attached to the cam follower portion 36 and the housing 32.

In operation, the first clamp 14 is initially in the outward position and the second clamp 18 is in the upward position. The gripper 10 is moved adjacent to a workpiece 12. The first actuator 24 is then actuated to move the clamp fingers 16 inward to grab the workpiece 12. The workpiece 12 is grabbed in a manner so that the part 12 is located within the shelves 20 of the fingers 16. The second actuator 28 is then actuated to move the second clamp 18 into the downward position to push the workpiece 12 into the first clamp 14. The gripper 10 and workpiece 12 may then be moved to a new location. The workpiece 12 may be released from the gripper 10 by actuating the actuators 24 and 28 and moving the clamps 14 and 18, accordingly.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. For example, although the second clamp 18 is described as applying a force to the workpiece 12, the clamp 18 may be moved to a position that inhibits movement of the part 12 without actual contact with the device 12.

What is claimed is:

1. A mechanical gripper, comprising:
a first clamp that clamps along a first axis;
a first actuator coupled to said first clamp;
a second clamp that clamps along a second axis; and,
a second actuator coupled to said second clamp.

2. The gripper of claim 1, wherein the second axis is essentially perpendicular to the first axis.

3. The gripper of claim 1, wherein said first actuator includes a pneumatic cylinder.

4. The gripper of claim 1, wherein said second actuator includes a pneumatic cylinder.

5. The gripper of claims 1, wherein said first clamp includes a pair of fingers.

6. The gripper of claim 5, wherein each finger includes a shelf.

7. The gripper of claim 5, wherein each finger includes an t-shaped portion.

8. The gripper of claim 1, further comprising a spring that biases said second clamp into a closed position.

9. The gripper of claim 1, further comprising a linear cam that is coupled to said second clamp and said second actuator.

10. A mechanical gripper that can hold a workpiece, comprising:
first clamp means for clamping the workpiece along a first axis; and,
second clamp means for clamping the workpiece along a second axis.

11. The gripper of claim 10, wherein the second axis is essentially perpendicular to the first axis.

12. The gripper of claim 10, wherein said first clamp means includes a pneumatic cylinder.

13. The gripper of claim 10, wherein said second clamp means includes a pneumatic cylinder.

14. The gripper of claim 10, wherein said first clamp means includes a pair of fingers.

15. The gripper of claim 14 wherein each finger includes a shelf.

16. The gripper of claim 14, wherein each finger includes an L-shaped portion.

17. The gripper of claim 13, wherein said second clamp means includes a spring that biases a second clamp into a closed position.

18. The gripper of claim 17, wherein said second clamp means includes a linear cam that is coupled to said second clamp and said pneumatic cylinder.

19. A method for gripping a workpiece, comprising:
moving a first clamp along a first axis to clamp the workpiece; and,
moving a second clamp along a second axis to inhibit movement of the workpiece within the first clamp.

20. The method of claim 19, wherein the second axis is essentially perpendicular to the first axis.
